(19) United States
(12) Patent Application Publication
(10) Pub. No.: US 2014/0149234 A1
(43) Pub. Date: May 29, 2014

(54) MANAGEMENT OF RESTAURANT INFORMATION AND SERVICE BY CUSTOMERS

(71) Applicant: Seth L. Neubardt, Mamaroneck, NY (US)

(72) Inventor: Seth L. Neubardt, Mamaroneck, NY (US)

(21) Appl. No.: 14/167,056

(22) Filed: Jan. 29, 2014

Related U.S. Application Data
(62) Division of application No. 13/374,912, filed on Jan. 23, 2012, now abandoned.
Application No. 13/374,912 is a continuation-in-part of application No. 12/454,259, filed on May 14, 2009, now abandoned.
(60) Provisional application No. 61/127,564, filed on May 14, 2008.

(51) Int. Cl. G06Q 50/12; G06Q 30/02; G06Q 20/20

(52) U.S. Cl. CPC G06Q 50/12; G06Q 20/20; G06Q 30/0282
USPC 705/15

(57) ABSTRACT

A method of managing restaurant information and service by restaurant customers. A point-of-sale (POS) device at a restaurant identifies a customer at the restaurant, links with a network server associated with a restaurant customer service to which the customer belongs, and transmits an amount owed by the customer for food or other items to a financial services provider. A server associated with the restaurant customer service allows the customer to create a personal file accessible only by the customer and others designated by the customer. Each personal file includes certain entries including a rating, review, or other information concerning restaurants patronized by the members of the customer service. The POS device prompts the customer for such entries after the financial services provider approves payment of the amount owed. The entries are then transmitted to the customer service for entry in the customer's personal file.

### CROSS REFERENCE TO RELATED APPLICATIONS

This application is a divisional of my copending U.S. patent application Ser. No. 13/374,912 filed Jan. 23, 2012, which is a continuation-in-part of my U.S. patent application Ser. No. 12/454,259 filed May 14, 2009, and which claims priority under 35 U.S.C. §119(e) of my U.S. Provisional Patent Application No. 61/127,564 filed May 14, 2008.

### BACKGROUND OF THE INVENTION

1. Field of the Invention

The present invention relates generally to storing, updating, and sharing relevant information concerning restaurants, particularly by restaurant customers.

2. Discussion of the Known Art

Systems are known that allow restaurant proprietors to obtain and manage responses to surveys and other sensitive customer-related data. Such systems often entice customers by offering rewards if they respond to survey questions presented on a point-of-sale (POS) device when paying their tab. See, e.g., Patent Appl'n Pub. No. US 2005/0043996 (Feb. 24, 2005) disclosing a system that collects and stores responses to a post dining survey that a customer enters when paying his or her check. The publication also states that the customer may log into a special web portal that provides a list of restaurants based on a set of preferences, but does not explain how or by whom the list or the preferences are compiled.

Patent Appl'n Pub. No. US 2007/0214052 (Sep. 13, 2007) discloses a “consumer driven” system for hospitality applications, using telecommunication technology integration. The system is described as allowing customers to obtain restaurant related information including blogs, and to make reservations at their old restaurant with seating and food selections. The publication does not detail how the system is actually constructed in order to carry out the alleged functionality, however. See also U.S. Pat. 7,281,652 (Oct. 16, 2007), describing a point-of-sale system having a customer information entry component for providing customer input to a database, wherein the database is supported by a financial service provider that implements a customer payment at the point-of-sale.

Patent Appl'n Pub. No. US 2002/0107717 (Aug. 8, 2002) describes a system for conducting consumer evaluations at a POS device such as a credit card reader at a restaurant. The POS device connects through a network with payment gateway and bank transaction servers to implement an authorized transfer of funds. The gateway also acts as a survey router that transmits survey questions originating from a survey processing server to a screen at the POS device, and routes corresponding answers back to the survey processing server.

Further, U.S. Pat. 7,310,350 (Dec. 18, 2007) relates a system for allowing mobile device users to participate in an online survey community. A web server is configured to produce a movie guide based on opinion data obtained from a community of mobile users. Like the system described in the above '717 publication, however, the system of the '350 patent does not allow a user to create a personal file into which he or she can enter a comment or other information that the user can elect to share with other system users.

### SUMMARY OF THE INVENTION

According to the invention, a method of managing restaurant information and service by customers includes providing, at a given restaurant, a point-of-sale (POS) device for (a) identifying a given customer at the restaurant, (b) linking with a server associated with a restaurant customer service of which the customer is a member, and (c) transmitting an amount owed by the customer for food or other items purchased by the customer at the restaurant to a server associated with a financial services provider of the customer. The server associated with the restaurant customer service enables a given member of the service including the given customer to create a personal file accessible only by the given member and by others designated by the member, and each personal file supports entries of a rating, a review, or other information by the member with respect to one or more restaurants patronized by the member.

The POS device prompts the given customer to enter a rating, a review, and/or other information concerning the given restaurant after an approval of the amount owed is received from the server associated with the financial services provider. The rating, review, and/or other information entered by the given customer in the POS device is transmitted to the network server associated with the restaurant customer service for entry in the personal file of the customer.

For a better understanding of the invention, reference is made to the following description taken in conjunction with the accompanying drawing and the appended claims.

### BRIEF DESCRIPTION OF THE DRAWING FIGURES

In the drawing:

FIG. 1 is a block diagram of a first embodiment of a method of managing restaurant information and service by customers, according to the invention;

FIG. 2 is a block diagram of a second embodiment of a method of managing restaurant information and service by customers, according to the invention;

FIG. 3 is a flow diagram portraying a transfer of financial data and customer review information in the embodiment of FIG. 1, according to the invention;

FIG. 4 is a flow diagram portraying a transfer of financial data and customer review information in the embodiment of FIG. 2, according to the invention;

FIG. 5 is a flow diagram of a transfer of financial data and customer review information using a customer's smartphone or other wireless device in the embodiment of FIG. 1, according to the invention;

FIG. 6 is a flow diagram of a transfer of financial data and customer review information using a customer's smartphone or other wireless device in the embodiment of FIG. 2, according to the invention;

FIG. 7 is a diagram illustrating communication links formed among a restaurant customer, a restaurant customer service network, and a local area network (LAN) at the restaurant, according to the invention;

FIG. 8 is a flow chart showing steps performed in an embodiment of the invention from a restaurant point of sale (POS) perspective; and

FIG. 9 illustrates various components that may form a restaurant customer network server in FIGS. 1 and 2.

### DETAILED DESCRIPTION OF THE INVENTION

The present invention enables a restaurant patron or customer to create a personal file that is accessible only by the customer and others specifically designated by the customer, and in which file the customer can enter rating or other information concerning a given restaurant when paying his or her check via a point-of-sale (POS) or other device at the restaurant. In addition, if the customer contemplates returning to a certain restaurant for which they previously entered comments in their personal file, they can first access their file on-line and review the entered comments before returning to the restaurant or calling the restaurant for a reservation.

In one embodiment, the personal customer files are administered by an on-line or Internet-accessible restaurant customer service that may be identified by a suggestive domain name such as, for example, “MyCheckPlease.com”. A number of restaurant patrons may, for example, register on line to become members of the service and elect to share their individual files with other service members and, if desired, with selected restaurant proprietors as well.

The POS device may include, for example, a magnetic stripe card reader that is constructed and arranged in a known manner for reading a patron's credit or debit card, and for completing a financial transaction by linking with a financial services provider associated with the card. The POS device may also be hard wired conventionally to a public switched telephone network (PSTN), or constructed in a known manner to operate wirelessly through a network access point provided at the restaurant premises.

In accordance with the invention, the POS device is also configured to access a personal file that has previously been created by the patron once the transaction is approved, for example, by (i) linking the patron to the mentioned restaurant customer service, (ii) prompting the patron to enter rating or other information concerning the restaurant, and (iii) inquiring whether or not any of the information entered by the patron may be shared with other members of the service and/or with the restaurant proprietor.

The POS device may be constructed and arranged to operate in a conventional manner insofar as the device recognizes a given restaurant customer either from a swipe of the customer's charge card, and/or from a personal identification number (PIN) entered by the customer. Once a positive identification is made, the POS device processes the transaction using, for example, one of two protocols.

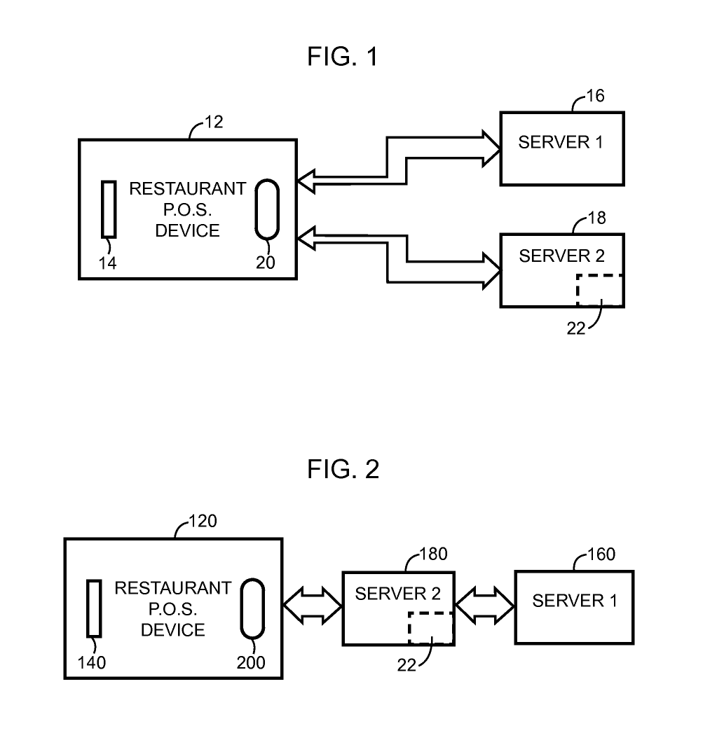

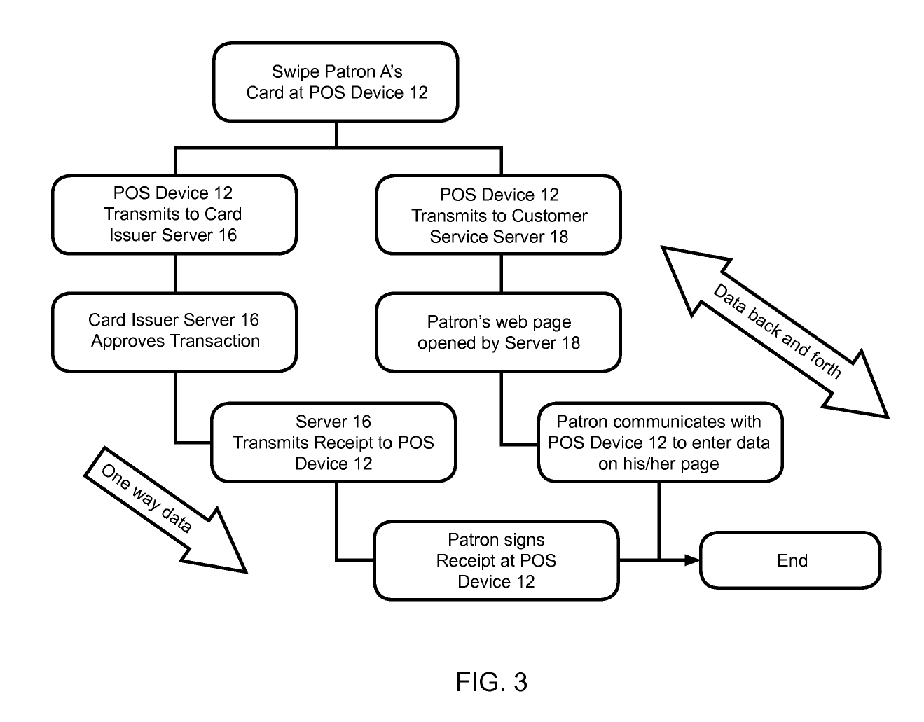

FIGS. 1 and 3 represent Example One below. In Example One, the POS device addresses a first message containing only the corresponding transaction data to a customer's financial services provider, and a second message containing only the customer's restaurant rating information is addressed to and entered into the customer's personal file maintained by the restaurant customer service.

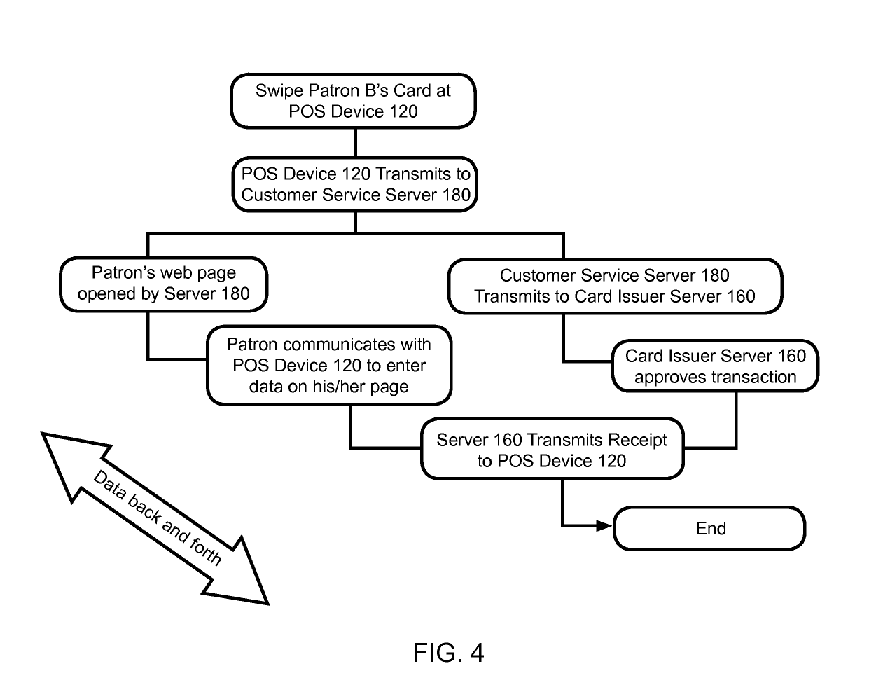

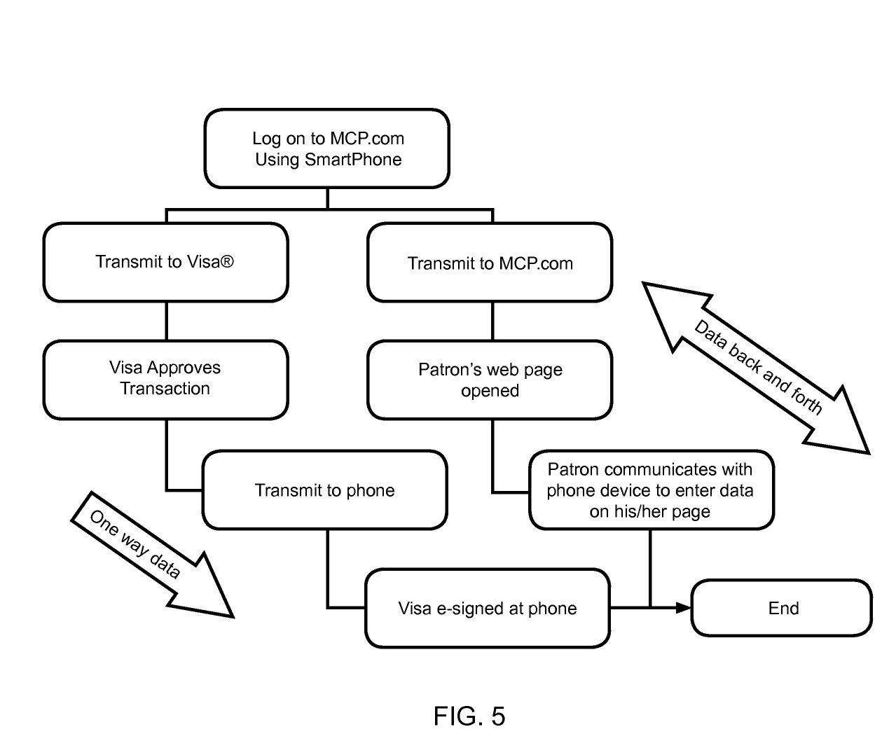

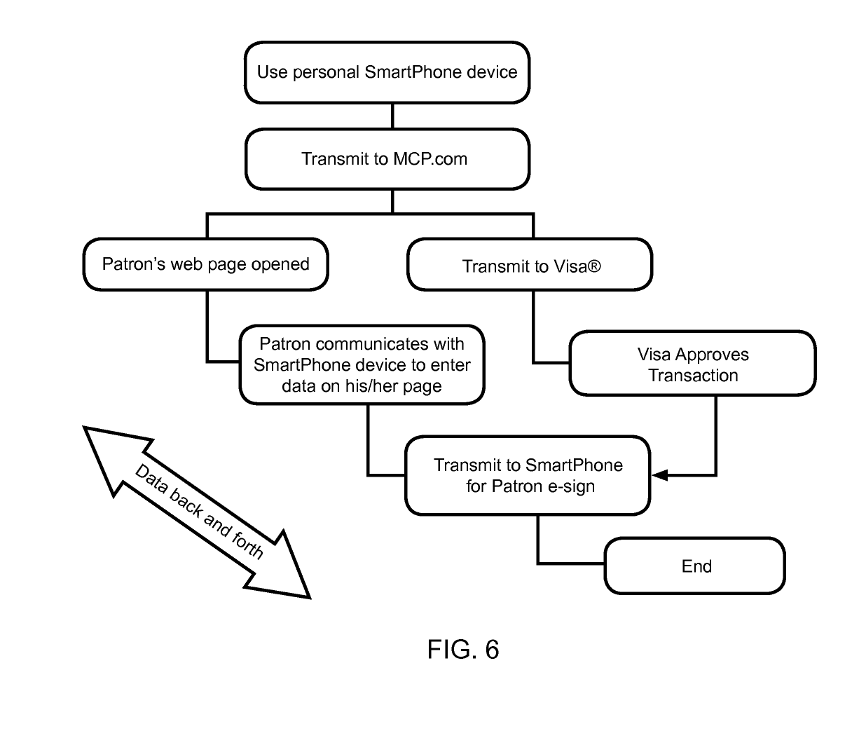

FIGS. 2 and 4 represent Example Two below. In Example Two, the transaction data and the rating information are combined in one message that is addressed to a server maintained by the restaurant customer service which, in turn, forwards the transaction data to a customer's financial services provider and reports back to the POS device. The POS device then accesses the customer's personal file and prompts the customer to add restaurant specific information or data in his or her file at that time. Alternatively, in lieu of a dedicated POS device, either protocol may be carried out by a customer's own wireless cell phone if, for example, the phone is a so-called currently available “smart” phone capable of being programmed and configured accordingly. See FIGS. 5 and 6.

### EXAMPLE ONE (FIGS. 1 and 3)

1. Customer A is presented with a restaurant check, and the restaurant cashier swipes customer A's credit card through a POS device 12 that has been configured according to the invention.

2. The POS device 12 recognizes the card, the amount owed is entered via an input keypad 14, and the device 12 addresses the corresponding financial transaction data (customer A's identity, amount charged, etc.) via a secure link to a server 16 maintained and/or operated by the credit card provider.

3. Once the transaction is approved, the server 16 generates a receipt for customer A's signature, and sends an acknowledgment message to the POS device 12.

4. Upon receipt of the acknowledgment message, the POS device 12 addresses another server 18 maintained and/or operated by the restaurant customer service. Customer A's personal file is identified by way of, e.g., his or her name and card number as were entered in the POS device 12, and access to customer A's file is provided by the server 18. A display 20 associated with the POS device 12 then prompts customer A to enter a review or other comments concerning the restaurant into his or her file by way of the keypad 14 on the POS device 12.

### EXAMPLE TWO (FIGS. 2 and 4)

1. Customer B is presented with a restaurant check, and the restaurant cashier swipes customer B's credit card through a POS device 120 that has been configured according to the invention.

2. The POS device 120 recognizes the card, the amount owed is entered via an input keyboard 140, and the device 120 addresses the corresponding financial transaction data (customer B's identity, amount charged, etc.) via a secure link to a server 180 maintained and/or operated by the restaurant customer service which, in turn, forwards the financial transaction data via a secure link to another server 160 maintained and/or operated by the credit card provider.

3. Once the transaction is approved, server 160 sends an acknowledgment message and a receipt for customer B's signature to the restaurant customer service server 180 which, in turn, forwards the receipt to the POS device 120.

4. Upon receipt of the acknowledgment message, the restaurant customer service server 180 also identifies customer B's personal file by way of, e.g., his or her name and credit card number, and access to customer B's file is also provided via the server 180. A display 200 associated with the POS device 120 then prompts customer B to add a review or other comments concerning the restaurant into his or her file by using the keypad 200 on the POS device 120.

In either Example One or Example Two, restaurant customers are afforded an opportunity to use a POS transaction device not only to pay for their meal purchase, but also to enter a review or other comments into their personal files to reflect their purchasing experience.

When members of the restaurant customer service elect to share information entered in their files based on their personal experiences with other service members, a database 22 reflecting combined member ratings for a number of restaurants can be compiled by the customer service server 18 or 180 using known database applications. The database 22 can also be configured in a known manner to be searchable by one or more subjects including food category, geographic location, price and the like, and made accessible exclusively to members of the service for their own use and benefit.

For members having smart phones or other wireless devices that provide Internet connectivity and are capable of being programmed by downloading desired applications (“Apps”) on-line, the inventive service allows a member who arrives at an unfamiliar destination to locate one or more restaurants whose menus and prices satisfy the member's needs. For example, upon arriving in Boston, a qualified member can log onto the customer service and enter a “Search for Restaurant” command. The member is then presented with a list of personal preferences from which he or she can select food type(s), food quality, quality of service, seating availability for breakfast, lunch or dinner, prices, and the like. The member's location in Boston is then entered by the member or, if the member's smart phone or wireless device is GPS enabled, the location is determined and transmitted seamlessly by the device to the address of the restaurant customer service host server 18 or 180 in FIG. 1 or 2. The host server is then programmed and configured to compare the member's location and selected preferences with corresponding information from the member compiled database, and/or from other sources including restaurants affiliated with the service.

The host server 18 or 180 then provides the traveling member with search results in which, for example, the top ten restaurants in or near Boston matching the member's preferences are ordered, together with an address and telephone number for each restaurant. If the member's wireless device is GPS enabled, a map of Boston can also be displayed on the device display with a marker superimposed at each restaurant location, and a numeral associated with the marker representing a ranking of the restaurant with respect to the member's preferences.

Once the member chooses a restaurant that suits him or her best, the inventive service can be configured in a known manner to provide the member with an option of having a reservation request transmitted to the restaurant for immediate acknowledgment. If desired, the option can apply only to those restaurants that are affiliated with or approved by the customer service. The member can also be prompted to enter one or more alternate restaurants in the event the first reservation choice is not obtained or confirmed.

As disclosed herein, the inventive service allows a restaurant patron to enter and store a personal review of their dining experience at the conclusion of their meal by using a wired or a wireless POS device provided at the restaurant, or by using the patron's own smart phone or wireless communications device when running a corresponding application. FIGS. 5 and 6 illustrate the use of a smart phone or other personal wireless communications device (e.g., a touch pad or tablet), according to the invention.

In the example of FIG. 5, upon acquiring Internet connectivity for his or her smart phone at a given restaurant by way of, e.g., a Wi-Fi access point (AP) at the restaurant or a wireless cellular network, a member of the restaurant customer service logs onto the customer service website (e.g., “MCP.com”) and opens their personal page or file after making a secure user identification. The member then enters their own rating or other information concerning the restaurant to be stored for their own future reference and, optionally, for sharing with other service members, the proprietor of the restaurant, and/or other restaurant owners who may also subscribe to the service.

If the member's smart phone or device is programmed in a known manner with one or more corresponding applications (which, for example, are made available for download to members by the customer service and/or their charge card providers), the member can (a) transmit an amount currently owed on their food bill to their charge card provider for approval by using their smart phone, (b) receive an approval in the form of a payment authorization to the restaurant, (c) add any desired gratuity, and (d) electronically sign and transmit the payment authorization upon which the program routine ends.

In the example of FIG. 6, the member acquires Internet connectivity for their smart phone or device at a given restaurant by way of an access point that is part of a local area network (LAN) operated by the restaurant. The member logs onto the customer service website and opens their personal page or file as in FIG. 5. The member then enters their rating or other information concerning the restaurant for future reference and, optionally, for sharing with other service members, the proprietor of the restaurant, and/or other restaurant owners who may also subscribe to the service.

If the member's smart phone or other communications device and the restaurant network are so programmed in a known manner, the restaurant network server can (a) transmit an amount owed by the member to the member's charge card provider for approval, either directly or through the customer service server as indicated in FIG. 6, (b) receive an approval in the form of a payment authorization to the restaurant to be signed by the member, and (c) transmit the authorization to the member's smart phone or device. The member can then add a gratuity if desired, electronically sign the payment authorization, and transmit the authorization upon which the program routine ends.

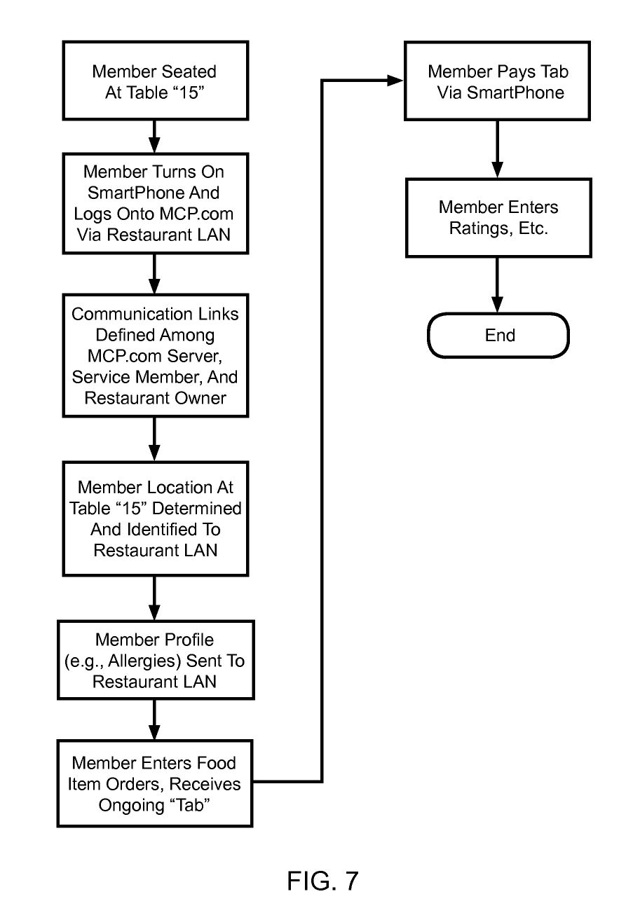

If the member's smart phone or other communications device is GPS enabled, or if the restaurant network has several access points, the member's physical location (e.g., table number) in a participating restaurant can be determined in a known manner and forwarded to the customer service server. Text or other types of communication links between the member, the customer service, and the restaurant kitchen or chef can then be defined using established protocols. See FIG. 7. The chef can then receive an alert directly from the customer service warning that according to a profile set up by the member who is currently sitting at, e.g., table # 15, the member has a peanut allergy or other potentially dangerous food sensitivity.

The above communication links also allow the member's food order to be entered by the member item by item in real-time using their smart phone or other wireless device, and for current amounts owed by the member to be transmitted from the restaurant network to the device periodically, e.g., every three minutes. Accordingly, the member can, for example, press a “pay” button on their device at any time and leave the restaurant shortly thereafter upon authorization of payment, all without a need for any verbal communication with a waiter or cashier. Such communication links also allow the member to accumulate and save a dining log in their personal file, showing food items ordered at each restaurant visit, and the amount charged for each item at the time of the visit.

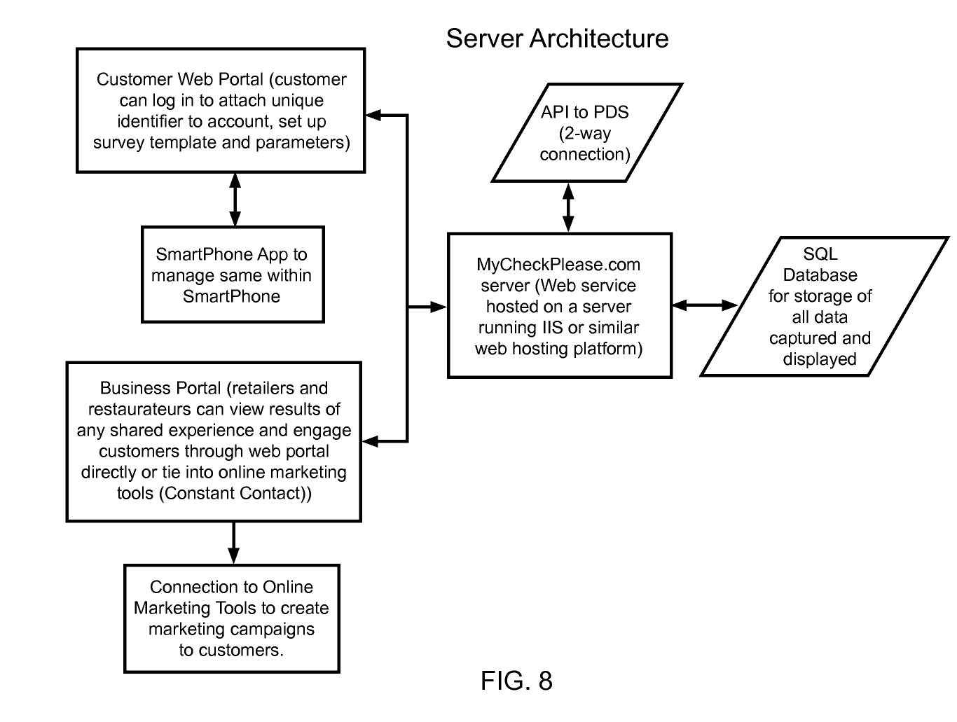

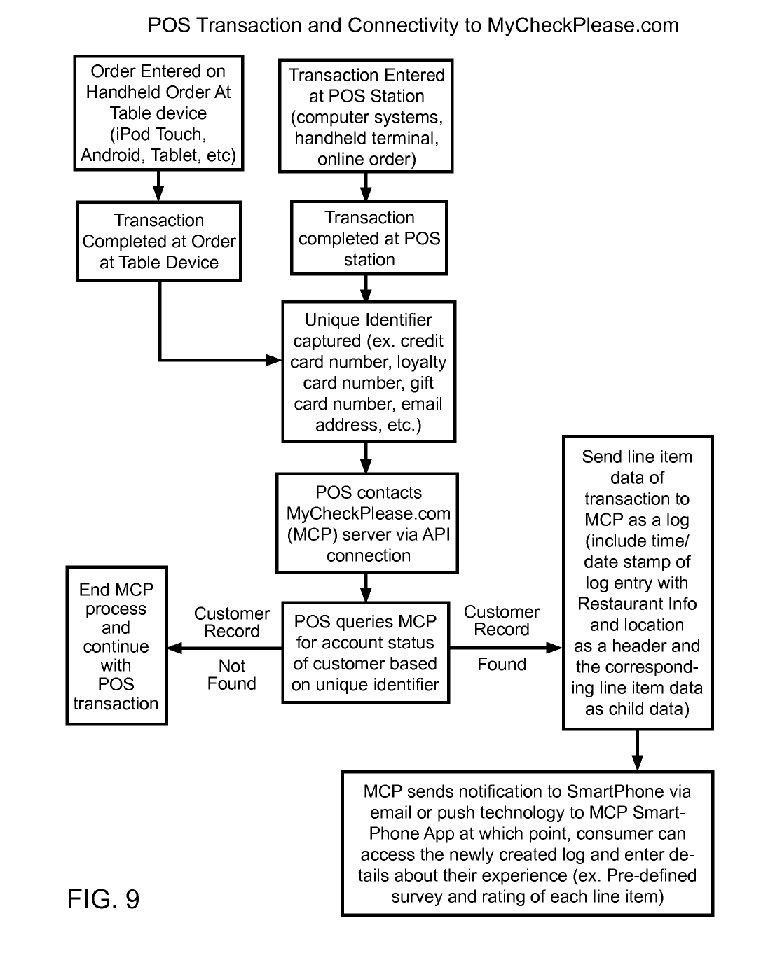

FIG. 8 is a flow chart illustrating steps carried out by an embodiment of inventive service from a restaurant point of sale (POS) perspective. FIG. 9 illustrates various components that can form the restaurant customer service server 18 or 180 in FIGS. 1 and 2.

The Customer Web Portal in the server architecture of FIG. 9 can include a setup area that allows members to create a new account, tie in their unique identifier, create custom templates for use in their ratings, and choose which ratings may be shared with a restaurant business and which remain anonymous. Members may also be allowed an option of connecting to their social networks for “blasting” their reviews to fellow network members.

As mentioned, members can also pull up restaurant logs which they create or which are created automatically by a restaurant's own POS stations at the end of each transaction. Members can also edit their stored reviews line by line or on an overall performance basis, and the templates for the logs and the reviews may be defined in the setup area. A separate Business Portal shown in FIG. 9 is associated with the server 18 or 180 to allow participating restaurant owners to connect with known online marketing tools such as, e.g., Constant Contact or similar e-mail marketing services.

While the foregoing represents preferred embodiments of the invention, it will be understood by those skilled in the art that various modifications, changes, and additions may be made without departing from the spirit and scope of the invention, and that the invention includes all such modifications, changes, and additions as are within the bounds of the following claims.

I claim:

1. A method of managing restaurant information and service by restaurant customers, comprising:
providing, at a given restaurant, a point-of-sale (POS) device constructed and arranged for;
(a) identifying a given customer at the restaurant,
(b) linking with a network server associated with a restaurant customer service of which the customer is a member, and
(c) transmitting an amount owed by the customer for food or other items purchased by the customer at the restaurant, to a server associated with a financial services provider of the customer;
configuring the server associated with the restaurant customer service to enable a member of the service including the given customer to create a corresponding personal file that is accessible only by the member and by others designated by the member including a proprietor of the given restaurant;
structuring each personal file to include entries by a member of the customer service corresponding to a rating, a review, or other information including food items served with respect to one or more restaurants patronized by the member;
configuring the POS device to prompt the given customer to enter a rating, a review, and/or other information concerning the given restaurant after a message approving the amount owed by the customer is received from the server associated with the financial services provider; and
transmitting the rating, review, and/or other information entered by the given customer in the POS device, to the network server associated with the restaurant customer service for entry in the personal file of the customer.

2. A method of managing restaurant information and service according to claim 1, including compiling, at the server associated with the restaurant customer service, a database corresponding to entries in a number of personal files created by different members of the restaurant customer service.

3. The method of claim 2, including structuring the database to reflect combined member ratings for each of a number of different restaurants, and configuring the database to be searchable by one or more of food category, geographic location, and price.

4. A method of managing restaurant information and service according to claim 1, including enabling the server associated with the restaurant customer service to be accessible via the Internet.

5. A method of managing restaurant information and service according to claim 1, including programming or configuring a smart phone or other personal wireless device that is operated by the given customer to function as the POS device.

6. The method of claim 5, including programming or configuring the smart phone or other personal wireless device to search for restaurants in the vicinity of the device, and to rank any uncovered restaurants according to certain defined attributes.

7. The method of claim 5, including programming or configuring the smart phone or other personal wireless device to transmit a reservation request to a selected restaurant in the vicinity of the device.

8. The method of claim 5, including providing a restaurant local area network (LAN) at the restaurant, and programming or configuring the restaurant LAN and the POS device to form communication links among the LAN including restaurant personnel, the POS device, the server associated with the restaurant customer service, and the server associated with the financial services provider.

9. The method of claim 8, including programming or configuring the restaurant LAN and the POS device to produce a dining log concerning food and other items served to the given customer at the restaurant, and transmitting the dining log to the server associated with the restaurant customer service for entry in a personal file created by the given customer.

10. The method of claim 8, including programming or configuring the restaurant LAN and the POS device to determine a location of the device operated by the given customer in the restaurant.

11. The method of claim 10, including programming or configuring the restaurant LAN to identify the given customer operating the POS device at the determined location.

12. The method of claim 11, including receiving, by the restaurant LAN, a member profile of the given customer including food alerts, if any, that are entered in the profile.

13. The method of claim 8, including programming or configuring the restaurant LAN to accept an order entered by the given customer on the POS device.

14. The method of claim 13, including configuring the restaurant LAN to transmit a current amount owed by the given customer to the POS device.

15. The method of claim 14, including transmitting, by the given customer, the amount owed from the POS device to the server associated with the financial services provider of the customer for approval.

16. A method of managing restaurant information and service according to claim 1, including configuring the server associated with the restaurant customer service to have a business portal for allowing restaurant proprietors to engage customers directly.

17. A method of managing restaurant information and service according to claim 1, including configuring the server associated with the restaurant customer service to have a business portal for allowing restaurant proprietors to connect with known marketing systems.
